(19) United States
(12) Patent Application Publication
(10) Pub. No.: US 2007/0294097 A1
(43) Pub. Date: Dec. 20, 2007

(54) METHOD AND APPARATUS FOR MONITORING EXECUTION OF A BUSINESS PROCESS MANAGED USING A STATE MACHINE

(75) Inventors: Laurent David HASSON, New York, NY (US); John Scott HOUSTON, Hopewell Junction, NY (US)

Correspondence Address: SAWYER LAW GROUP LLP, P.O. BOX 51418, PALO ALTO, CA, 94303, US

(73) Assignee: INTERNATIONAL BUSINESS MACHINES CORPORATION, Armonk, NY (US)

(21) Appl. No.: 11/669,394

(22) Filed: Jan. 31, 2007

Related U.S. Application Data
(63) Continuation of application No. 09/951,025, filed on Sep. 12, 2001, now abandoned.

(51) Int. Cl. G06Q 10/00

(52) U.S. Cl. 705/1

(57) ABSTRACT

A state-based method and apparatus are disclosed for tracing and auditing a business process managed using a state machine. The disclosed system can selectively vary the tracing and auditing based, for example, upon the specific state within the business process or the identity of the organization or user associated with a given transaction. An organization can indicate whether any trace or audit information (or both) should be collected for the organization. In addition, the specific information that is collected for a given state in the state machine can be separately specified for a trace mode or audit mode. Trace and audit records can be tailored to the organization and situation at hand. the collected trace and audit information reflect the values associated with the object at well-defined points in time since they are associated with the states of the business process.

### CROSS-REFERENCE TO RELATED APPLICATIONS

This application is a continuation of U.S. application Ser. No. 09/951,025, filed on Sep. 11, 2001, which is related to U.S. application Ser. No. 09/951,028, filed on Sep. 11, 2001, U.S. application Ser. No. 09/951,027, files on Sep. 11, 2001, U.S. application Ser. No. 09/951,026, filed on Sep. 11, 2001, U.S. application Ser. No. 09/951,024, filed on Sep. 11, 2001, and U.S. application Ser. No. 09/951,029, filed on Sep. 11, 2001, all of which is incorporated by reference in its entirety for all purposes as if fully set forth herein.

### FIELD OF THE INVENTION

The present invention relates generally to techniques for representing business processes as state machines, and more particularly, to a method and apparatus for monitoring the execution of a business process that is managed using a state machine.

### BBACKGROUND OF THE INVENTION

The execution of a complex business process, such as a transaction server for an e-commerce application, must often be monitored to identify the source of errors or inefficient performance and to develop an audit trail. A number of debugging tools have been developed that monitor the execution of a software program and generate a trace file that may be analyzed to determine the source of errors or inefficient performance. For example, various analysis tools exist that allow a programmer to insert debugging code into specific portions of a software program that will create an entry in a trace file each time the inserted portions of the code are executed.

Similarly, a number of auditing tools have been developed that monitor the execution of a software program and generate an audit trail to document, for example, the identity of individuals who perform certain tasks. Various auditing tools exist that generate an entry in an audit file each time certain tasks are performed. The audit file entries may identify, for example, the time of the task and the individual associated with the task.

The requirements for tracing and auditing interactions typically differ from one organization to another, or even from one user to another user of the same system. The tracing and auditing requirements may depend, for example, on the needs of the organization, the process being monitored and the needs of the software and services organizations to resolve problems experienced by a web site and by its users. For example, different users may encounter different problems or the dame problem in a different way while performing the same transaction. Therefore, it may be desirable for a trace tool to collect user-specific information in order to identify and resolve these problems. Similarly, with regard to collect audit information, some organizations may be required by law (or their own business needs) to retain detailed audit trails that indicate who performed each action during some transaction. Meanwhile, another organization, using the same business process, may only need minimal audit trails for activities related to certain transactions, such as those exceeding a certain dollar amount.

A need therefore exists for an improved method and apparatus for monitoring the execution of a business process. Yet another need exists for a software monitoring tool that minimizes the impact on the overall performance of the business system. In addition, a further need exists for a software monitoring tool that provides a state-based tracing and auditing system that may be varied based upon the specific state within the business process, as well as the identity of the organization or user associated with a given transaction.

### SUMMARY OF THE INVENTION

Generally, a state-based method and apparatus are disclosed for tracing and auditing a business process managed using a state machine. The disclosed system can selectively vary the tracing and auditing based, for example, upon the specific state within the business process or the identity of the organization or user associated with a given transaction. In one exemplary implementation, flags can be defined for an organization to indicate whether any trace and audit information should be collected for the organization. Similarly, the specific information that is collected for a given state in the state machine can be separately specified for a trace mode or audit mode.

The present invention allows trace and audit records to be tailored to the organization and situation at hand. In addition, the collected trace and audit information reflect the values associated with the object at well-defined points in time since they are associated with the states of the business process.

A more complete understanding of the present invention, as well as further features an advantages of the present invention, will be obtained by reference to the following detailed description and drawings.

### BRIEF DESCRIPTION OF THE DRAWINGS

FIG. 1 illustrates an exemplary conventional state machine having two state for managing a business process;

FIG. 2 is a sample table from an exemplary flow state dictionary table;

FIG. 3 is a sample table from an exemplary membership trace and audit table;

FIG. 4 illustrates an exemplary state machine for managing an order process in accordance with the percent invention; and

FIG. 5 illustrates an exemplary network environment in which the present invention can operate.

### DETAILED DESCRIPTION

The present invention provides a state-based method and apparatus for tracing and auditing a business process that is managed using a state machine. The disclosed system can vary the tracing and auditing based, e.g., upon the specific state within the business process or the identity of the organization or user associated with a given transaction.

State Machine Terminology

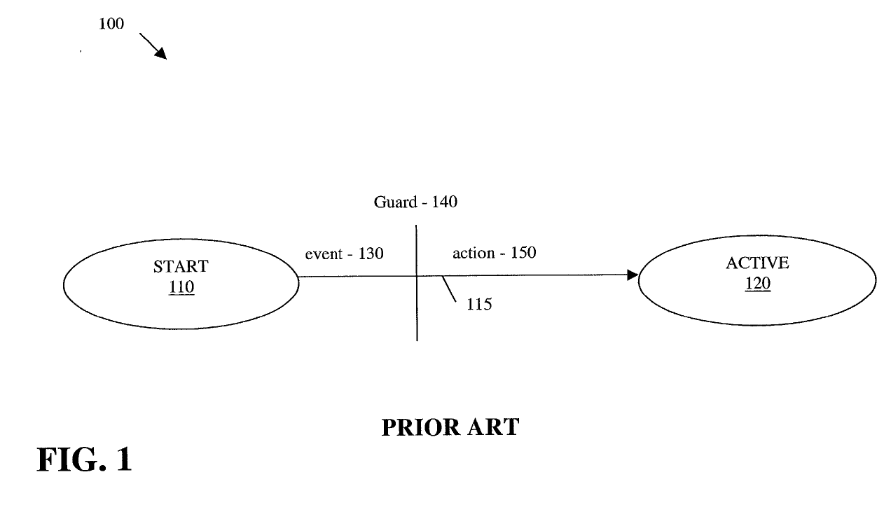

Business process can be represented using a state machine. State machines provide a way to control the set of event and actions that may be performed throughout the life cycle of a business object. The Unified Modeling Language (UML) provides a standardized syntax for describing state machines. FIG. 1 illustrates an exemplary conventional state machine 100 having two states 110, 120, with a single transition 115 leading from the Start state 110 to the Active state 120. The transition 115 is composed of three parts. First, there is an event 130 that defines what may cause this transition 115 to be attempted. Second, one or more guards 140 determine whether or not the transition 115 may be taken based upon some predefined criteria. such as the authority of the user or certain values associated with the business object. Finally, the action 150 provides a means for identifying logic that may act upon, or on behalf of, the object being managed by the state machine 100. Thus, if the transition 115 is allowed according to the guards 140, then the action 150 is performed and the object moves onto the Active state 120. The various components of a transition 115 can be expressed using the notation “event [guard] action.”

For a more detailed discussion of techniques for managing business processing using a state machine, see, for example, U.S. patent application Ser. No. 09/818,719, files on Mar. 27, 2001, entitled “E-Market Architecture for Supporting Multiple Roles and Reconfigurable Business Processes,” August-Wilhelm Scheer, Aris—Business Process Modeling, Springer Verlag, 1999 or Peter Muth et al., Enterprise-Wilde Workflow Management Based on State and Activity Charts, in A. Dogac, L. Kalinichenko, T. Ozsu, A. Aheth (Editors), Workflow Management Systems and Interoperability, Springer Verlag, 1998, each incorporated by reference herein.

Consider two exemplary business that participate in an online business-to-business marketplace, such as the XYZ Corporation and LMNOP Company. The business process that they each use for managing an auction may be virtually identical, so they both choose the same business process from those available at a web site. However, due to difference in the corporate structure of each company, their needs for audit trails may be extremely different. The XYZ Corporation, a public corporation, may need to record every decision made about every transaction. On the other hand, the LMNOP Company is a small privately-owned business and only needs to save information required for tax purposes. Thus, the audit trail needs to the LMNOP Company are significantly different from the needs of the XYZ Corporation.

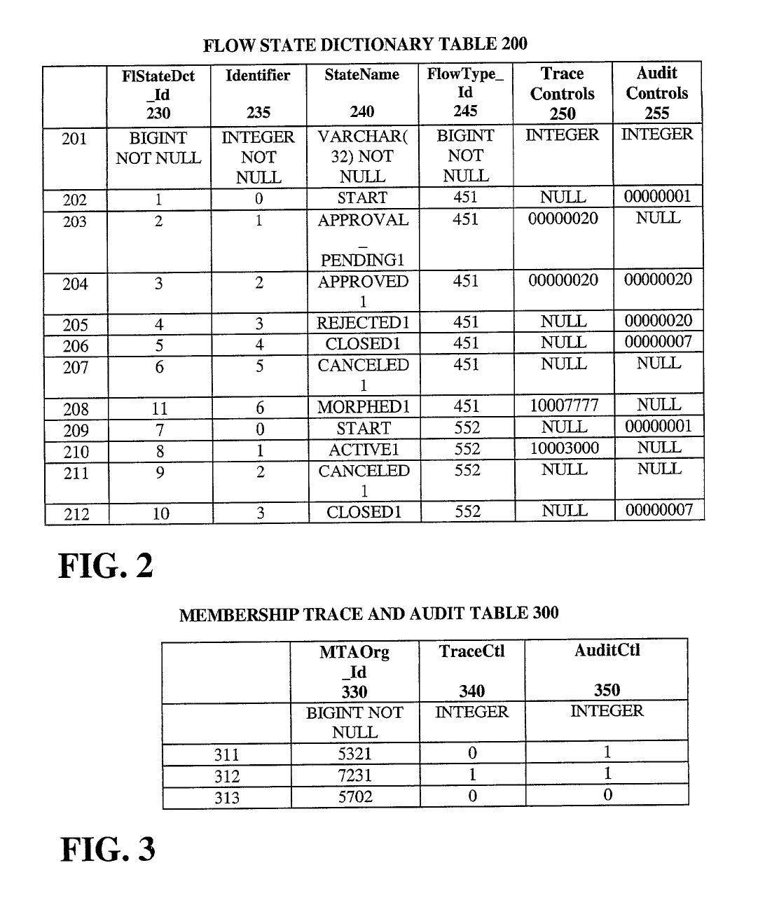

When a state machine is used to manage business processes, information about each state may be saved in a database table, such as the flow state dictionary table 200 shown in FIG. 2. The flow state dictionary table 200 includes a plurality of records, such as records 201-212, each associated with a different state in the state machine. For each state identified in field 230, the flow state dictionary table 200 stores, among other things, an identifier in field 235 that uniquely identifies the state within a Flow Type, the name of the states in field 240, the flow type to which the state belongs in field 245, and trace and audit controls in fields 250 and 255, respectively. The value of the trace and audit fields 250, 255 may indicate the type of information which must be saved in the trace or audit records. A value of NULL indicates that there is no trace or audit data to be saved with respect to this state.

FIG. 3 is a sample table from an exemplary membership trace and audit table 300. Generally, the membership trace and audit table 300 that records organization-based trace and audit controls. As shown in FIG. 3, the membership trace and audit table 300 has a plurality of records, such as records 311-313, each associated with a different organization. For each organization identifies in field 330, the membership trace and audit table 300 indicates whether trace and audit information should be collected in fields 340 and 350, respectively. For example, a binary value of one might indicate that the corresponding information should be collected. Thus, the organization associated with record 312 records both auditing and trace information, while the organization associated with record 311 records only auditing information.

Thus, the value stored in fields 340 and 350 of the membership trace and audit table 300 will determine whether any trace audit information, respectively, should be collected for the organization, and the values stored in fields 250 and 255 if the flow state dictionary table 200 will identify the nature of the trace and audit information, respectively, that should be collected. For example, 00000020 for the trace controls, as recorded in field 250 of entries 203 and 204, may indicate that the user identifier who invoked the transition should be collected when the trace mode is activated by an organization.

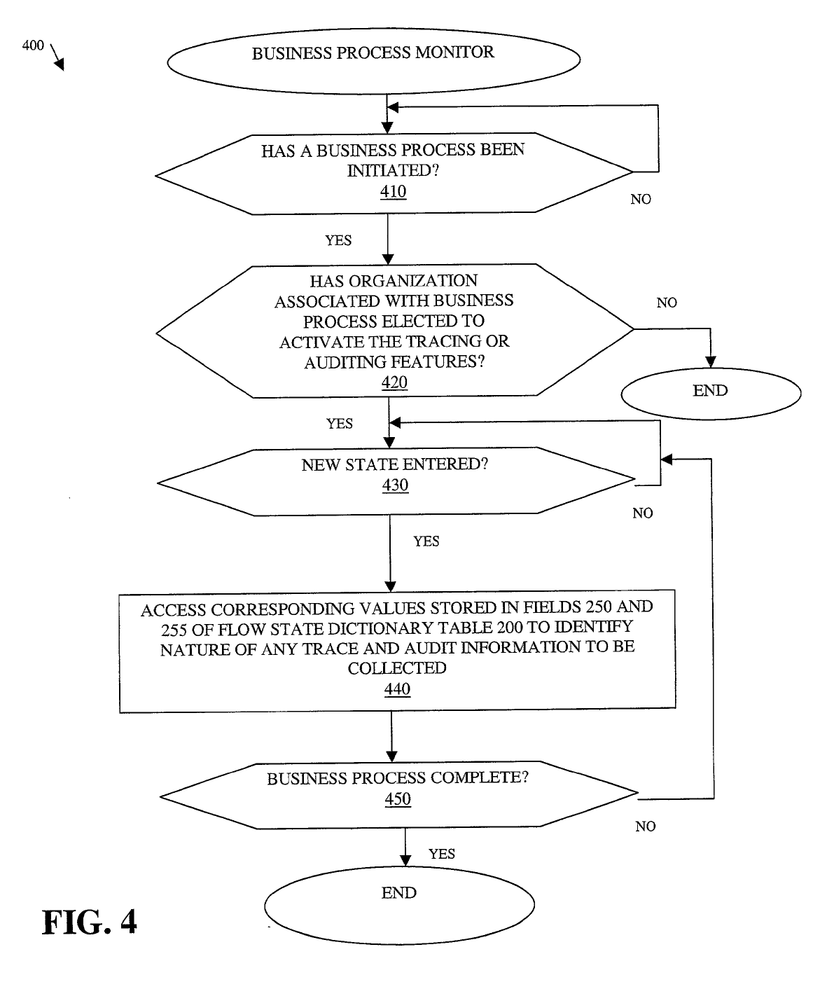

FIG. 4 is a flow chart describing an exemplary business process monitor 400. As shown in FIG. 4, the business process monitoring process 400 is initiated during step 410 in conjunction with the initiation of a business process. A test is performed during sep 420 to determine if the organization associated with the business process has elected to activate the tracing or auditing features of the present invention (by accessing the values stored in fields 340 and 350 of the membership trace and audit table 300). If it is determined during step 420 that the organization has elected to activate the tracing or auditing features of the present invention, then program control terminates at 460a while the business process continues executing in a conventional manner.

If, however, it is determined during step 420 that the organization has elected to activate the tracing or auditing features of the present invention, then a determination is made in step 430 as to whether a new state has been entered. If it is determined during step 430 that a new state has not been entered, then step 430 is repeated; otherwise, as the business process progresses through the entry object of each state, the corresponding values stored in fields 250 and 255 of the flow state dictionary table 200 are accessed during step 440 to identify the nature of any trace and audit information, respectively, that should be collected. A determination is then made in step 450 as to whether the business process is complete. If it is determined during step 450 that the business process is complete, then business process monitoring method 400 is terminated at 460b; otherwise, step 430 is repeated.

In placing control of the tracing and auditing under the control of the business process manager, performance gains can be made by not checking the criteria everywhere throughout the commands. The trace and audit records can be tailored to save only the information required for the situation at hand, and the trace and audit information reflect the values associated with the object at well-defined points in time since they are associated with the states of the process. The advantages of these features are significant and well beyond the current art in regard to trace and audit controls.

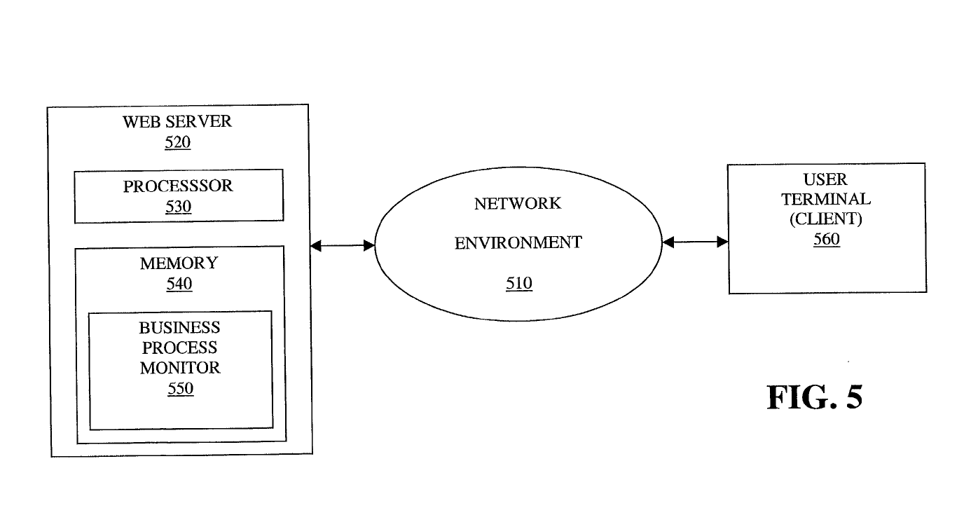

FIG. 5 illustrates an exemplary network environment 510 in which the present invention can operate. As shown in FIG. 5, a web server 520 communicates over a network 510 with a user terminal 560. For example, the user 560 may submit an order for goods or services to the web server 520. The transaction may be monitored in accordance with a business process monitor 550 incorporating features of the present invention, as discussed above in conjunction with FIG. 4. The network 510 can be any wired or wireless network for transferring information, such as a data network or a telephone network.

Memory 540 will configure the processor 520 to implement the methods, steps, and functions disclosed herein. The memory 540 could be distributed or local and the processor 530 could be distributed or singular. The memory 540 could be implemented as a electrical, magnetic or optical memory, or any combination of these or other types of storage devices. The term “memory” should be constructed broadly enough to encompass any information able to be read form or written to an address in the addressable space accessed by processor 520. With this definition, information on a network 510 is still within 540 of the web server 520 because the processor 530 can retrieve the information from the network 510.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

It is to be understood that the embodiments and variations shown and described herein are merely illustrative of the principals of this invention and that various modifications may be implemented by those skilled in the art without departing from the scope and spirit of the invention.

What is claimed is:

1. A method for monitoring a business process, the method comprising:
determining whether the business process has been initiated, the business process being associated with one or more organizations and being managed by a state machine comprising a plurality of states; and
initiating a monitoring process responsive to initiation of the business process, the monitoring process being operable to
determine a least one of the one or more organizations associated with the business process has elected to collect a set of information relating to at least on of the plurality of states of the state machine,
monitor the state machine to determine whether the state machine has transitioned into the at least one state responsive to the at least one organization electing to collect the set of information relating to the at least one state, and
collect the set of information relating to the at least one state responsive to the state machine transitioning into the at least one state.

2. The method of claim 1, wherein the set of information to be collected is specified in a first database table.

3. The method of claim 1, wherein the monitoring process is further operable to:
determine whether the at least one organization has elected to collect another set of information relating to at least another of the plurality of states of the state machine,
monitor the state machine to determine whether the state machine has transitioned into the at least one other state responsive to the at least one organization electing to collect the other set of information relating to the at least one other state, and
collect the other set of information relating to the at least one other state responsive to the state machine transitioning into the at least one other state.

4. The method of claim 3, wherein the set of information to be collected for the at least one state differs from the other set of information to be collected for the at lest on other state.

5. The method of claim 1, wherein the election by each of the one or more organizations associated with the business process to collect or not collect the set of information relating to the at least one state is specified in a second database table.

6. The method of claim 1, wherein the set of information collected is utilized to identify one or more sources of error or inefficient performance in the business process.

7. The method of claim 1, wherein the set of information collected id utilized to audit one or more transactions of the business process.

8. The method of claim 1, wherein the business process is an e-commerce application.

9. A computer program product comprising a computer readable medium, the computer readable medium including a computer readable program for monitoring a business process, the computer readable program comprising program instructions for:
determining whether the business process has been initiated, the business process being associated with one or more organizations and being managed by a state machine comprising a plurality of states; and
initiating a monitoring process responsive to initiation of the business process, the monitoring process being operable to
determine whether at least on of the one or more organizations associated with the business process has elected to collect a set of information relating to at least one of the plurality of states of the state machine,
monitor the state machine to determine whether the state machine has transitioned into the at least one state responsive to the at least one organization electing to collect the set of information relating to the at least one state, and
collect the set of information relating to the at least one state responsive to the state machine transitioning into the at least one state.

10. The computer program product of claim 9, wherein the monitoring process is further operable to:
determine whether the at least one organization has elected to collect another set of information relating to at least another of the plurality of states.
monitor the state machine to determine whether the state machine has transitioned into the at least on other state responsive to the at least on organization electing to collect the other set of information relating to the at lest one other state, and
collect the other set of information relating to the at lest one other state responsive to the state machine transitioning into the at least one other state.

11. The computer program product of claim 10, wherein the set of information to be collected for the at least one state differs from the other set of information to be collected for the at least one other state.

12. The computer program product of claim 9, wherein the set of information collected is utilized to identify one or more sources of error or inefficient performance in the business process.

13. The computer program product of claim 9, wherein the set of information collected is utilized to audit one or more transactions of the business process.

14. A system for monitoring a business process, the system comprising:
a memory operable to store computer-readable code; and
a processor in communication with the memory, the processor being operable to execute the computer-readable code stored in the memory, wherein the computer-readable code comprises instructions for:
determining whether the business process has been initiated, the business process being associated with one or more organizations and being managed by a state machine comprising a plurality of states, and
initiating a monitoring process responsive to initiation of the business, the monitoring process being operable to
determine whether a least one of the one or more organizations associated with the business process has elected to collect a set of information relating to at least one of the plurality of states,
monitor the state machine to determine whether the state machine has transitioned into the at least one state responsive to the at least one organization electing to collect the set of information relating to the at least one state, and
collect the set of information relating to the at least one state responsive to the state machine transitioning into the at least one state.

15. The system of claim 14, wherein the set of information to be collected is specified in a first database table.

16. The system of claim 14, wherein the monitoring process is further operable to:
determine whether the at least one organization has elected to collect another set of information relating to at least another of the plurality of states,
monitor the state machine to determine whether the state machine has transitioned into the at least one other state responsive to the at least one organization electing to collect the other set of information relating to the at least one other state, and
collect the other set of information relating to the at least one other state responsive to the state machine transitioning into the at least one other state.

17. The system of claim 16, wherein the set of information to be collected for the at least one state differs from the other set of information to be collected for the at least one other state.

18. The system if claim 14, wherein the election by each of the one or more organizations associated with the business process to collect or not collect the set of information relating to the at least one state is specified in a second database table.

19. The system of claim 14, wherein the set of information collected is utilized to identify one or more sources of error or inefficient performance in the business process.

20. The system of claim 14, wherein the set of information collected is utilized to audit one or more transactions of the business process.
